(19) United States
(12) Patent Application Publication
(10) Pub. No.: US 2007/0183080 A1
(43) Pub. Date: Aug. 9, 2007

(54) Portable electronic device

(75) Inventors: Yasuhiko Abe, Niiza-shi (JP); Yoshiyuki Matsubara, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/493,258

(22) Filed: Jul. 26, 2006

(30) Foreign Application Priority Data
Feb. 8, 2006 (JP) 2006-031502

(51) Int. Cl. G11B 5/596; G11B 15/04

(52) U.S. Cl. 360/77.04; 360/60

(57) ABSTRACT

A memory to store a state identifier showing whether or not to permit reading out an occurrence number of times of disk shifts from a disk storage unit is newly provided so as to intermittently change the identifier from a first state to a second state. When access requests to the disk unit are made, information showing the occurrence number of times of the disk shifts is read from the storage unit along with a data writing or reading operation to and from the storage unit. After a completion of reading the information, the identifier is returned from the second state to the first state. The identifier is changed from the first state to the second state with a determined time interval which is set longer than, for example, a minimum value of occurrence time intervals of the access requests.

### CROSS-REFERENCE TO RELATED APPLICATIONS

This application is based upon and claims the benefit of priority from prior Japanese Patent Application No. 2006-031502, filed Feb. 8, 2006, the entire contents of which are incorporated herein by reference.

### BACKGROUND OF THE INVENTION

1. Field of the Invention

The present invention relates to a portable electronic device, for instance, a portable communication terminal such as a cellular phone and a personal digital assistant (PDA) and a portable electronic device such as a portable game machine, an audio/video player and a digital camera. In particular, the present invention relates to a portable electronic device with a built-in disk storage unit.

2. Description of the Related Art

In recent years, the number of portable communication terminals such as cellular phones with a function of down-loading contents from a website and storing them has greatly increased. In such a terminal, an increase in a capacity of a storage medium is absolutely essential, and to respond to this request, an adaptation of a magnetic disk storage unit using a hard disk as the storage medium has been considered. However, the disk storage unit is generally weak against impact and sometimes causes eccentricity of a rotary shaft, namely a so-called disk shift, to pose an abnormality in a track trace, etc., when an impact is applied to the disk. Such a type of failure has a possibility to be frequently caused particularly in the portable communication terminal always carried and used by a user, which poses an important problem to be solved.

Therefore, as disclosed in, for instance, Jpn. Pat. Appln. KOKAI Publication No. 2005-174510, a magnetic disk storage unit with an impact occurrence notifying function has been developed. When disk shifts occur due to impacts on the storage unit, the notifying function calculates an amount of the disk shifts to predict an impact amount on the basis of the calculated value. The function determines whether or not an excessive impact has been applied to the storage disk in accordance with the prediction result of the impact amount to notify the determination result. Provision of a function to store an occurrence number of times of the disk shifts for the storage disk itself is a possible approach.

However, to read out the occurrence number of times of the disk shifts from the magnetic disk storage unit requires accessing a magnetic disk, which involves rotating the disk each time. A rotation operation of the disk has an upper limit frequency to secure the operation. Therefore, accessing to read out the occurrence number of times of the disk shifts, in addition to usual accessing to perform usual data writing or reading, causes deterioration in durability of the disk because an access frequency to the disk is increased.

On the other hand, to solve such a problem, reading out the occurrence frequency of disk accesses by using the usual accessing to write or read out the data has been studied. In this method, disk accessing only for reading out the occurrence frequency of the disc accesses has not been performed, so that the deterioration in durability of the disk is reduced. In contrast, if the disk storage unit reads out the occurrence number of times of the disk shifts every time the usual data writing or reading out is performed, an adverse effect such as a processing delay in usual data write-in or read-out processing occurs. And also the reading out processing poses an increase in consumption current to shorten a service life of a battery.

### BRIEF SUMMARY OF THE INVENTION

The present invention provides a portable electronic device capable of reading out an occurrence frequency of disk shifts without increasing an access frequency to a disk storage unit, also without delaying usual data write-in or read-out processing and increasing a consumption current, and thereby, capable of improving reliability and extending a service life of a battery.

One object of the present invention is to provide a memory to store a state identifier indicating whether or not to permit reading out information related to disk shifts to temporarily change the identifier stored in the memory from a first state to a second state. Then, in a state in which the identifier is set to the second state, when an access request to the disk storage unit is made, information about the occurrence number of times of the disk shifts is read out from the storage unit along with a data writing or reading operation to and from the disk storage unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing a configuration of a cellular phone that is an embodiment of a portable electronic device regarding the invention;

FIG. 2 is an exemplary block diagram showing a principal configuration of the cellular phone shown in FIG. 1;

FIG. 3 is an exemplary block diagram showing a configuration of a control module shown in FIG. 2;

FIG. 4 is an exemplary flowchart showing a procedure and contents of flag management control by the control module shown in FIG. 3;

FIG. 5 is an exemplary flowchart showing a procedure and contents of flag ON processing in the flag management control shown in FIG. 4,

FIG. 6 is an exemplary flowchart showing a procedure and contents of hard disk access processing by the control module shown in FIG. 3; and

FIG. 7 is an exemplary view showing a configuration of a hard disk history management area in an internal storage device shown in FIG. 2.

### DETAILED DESCRIPTION OF THE INVENTION

At first, a brief overview of a portable electronic device regarding the invention will be given.

An embodiment of the invention is a portable electronic device with a disk storage unit having a function to store information showing an occurrence frequency of disk shifts is constituted as follows. That is, the electronic device is newly provided with a memory storing a state identifier indicating whether or not the device allows reading out the occurrence number of times of the disk shifts to intermittently change the identifier from a first state to a second state. Then, if an access request has been raised in a state in which the identifier is set to the second state, the device reads out information showing the occurrence number of times of the disk shifts from the storage unit along with a data writing or reading operation to and from the storage unit. After an end of reading out the information showing the occurrence number of times of the disk shifts, the device returns the identifier from the second state to the first state. The identifier changes its state from the first state to the second state with a fixed time interval which is set, for instance, longer than a minimum value of occurrence time intervals of access requests.

Therefore, since the data reading out processing of the information showing the occurrence number of times of the disk shifts is performed along with data write-in or read-out processing to and from the storage unit, it becomes possible for the device to reduce a frequency of disk accesses and enhance durability of a disk. In addition, by using the state identifier, the reading out processing of the occurrence number of times of the disk shifts is not performed at every usual data write or read, and is intermittently performed with a time interval longer than that of the reading processing. Therefore, the device can reduce a reading frequency of the occurrence number of times of the disk shifts. A processing delay of the usual data writing and reading processing is thereby reduced, and the device enables speeding up the disk access by the reduction above. And it also becomes possible to reduce a current consumption to extend a service life of a battery.

Further, the invention is featured by providing a variety of types of configurations, as follows.

The state identifier may change its state from the first state to the second state at the time when power supply of the portable electronic device is turned on. By this manner, it becomes possible to read out the information showing the occurrence number of times of the disk shifts at the first disk access after the power supply is turned on and to surely record an occurrence situation of the disk shifts during a period of power-off.

When reading out the information showing the occurrence number of times of the disk shifts from the disk storage unit, the device may perform the reading in preference to a data writing or reading operation. In such a manner, the device can read out the information showing the occurrence number of times of the disk shifts further surely from the disk without being affected by the data write-in or read-out processing. In general, a portable electronic device becomes unable to make an access because of a reduction in a battery voltage or breaks down resulting from an impact during processing of data write-in or read-out processing into or from the disk storage unit. However, by reading the information showing the occurrence number of times of the disk shifts in preference, for instance, to data write-in or read-out processing, even when such failure occurs, the device becomes able to certainly read out the information showing the occurrence number of times of the disk shifts.

Furthermore, when storing the information showing the occurrence number of times of the disk shifts which has been read out from the storage unit in a non-volatile memory by associating it with information indicating the reading data, the following processing is preferable. That is, for each time when the information showing the occurrence number of times of the disk shifts is read out, the device determines whether an occurrence frequency which has been read out this time differs or not from an occurrence frequency which was read previously. And at every change of the occurrence frequency which has been read out this time in comparison to the occurrence frequency which was read in the past, the device associates the information relating to the occurrence number of times of the disk shifts with the information indicating the reading date to additionally store it in a first storage area of the non-volatile memory. And in addition to this, every time the information showing the occurrence number of times of the disk shifts has been read out from the storage unit, the device update-stores the information indicating the latest reading date in a second storage area of the non-volatile memory together with the read out information showing the occurrence number of times of the disk shifts.

In this way, the portable electronic device can store a history of a change in the occurrence number of times of the disk shifts in the first storage area, and also the device can store the occurrence number of times of the disk shifts which was read out at the most recent disk access and its reading date in the second storage area in addition to the forgoing history. Accordingly, the occurrence time of the disk failure can be predicted from the history recorded in the first storage area. And also the device can specify the elapsed time from the date at which the occurrence number of times of the disk shifts was changed up to the latest reading date on the basis of the information stored in the second storage area. Thereby, the device can accurately grasp the operation state of the disk storage unit from the time at which the last impact was made on the storage unit up to the current time.

Hereinafter, embodiments of the portable electronic device regarding the present invention will be set forth in a description with reference to the drawings.

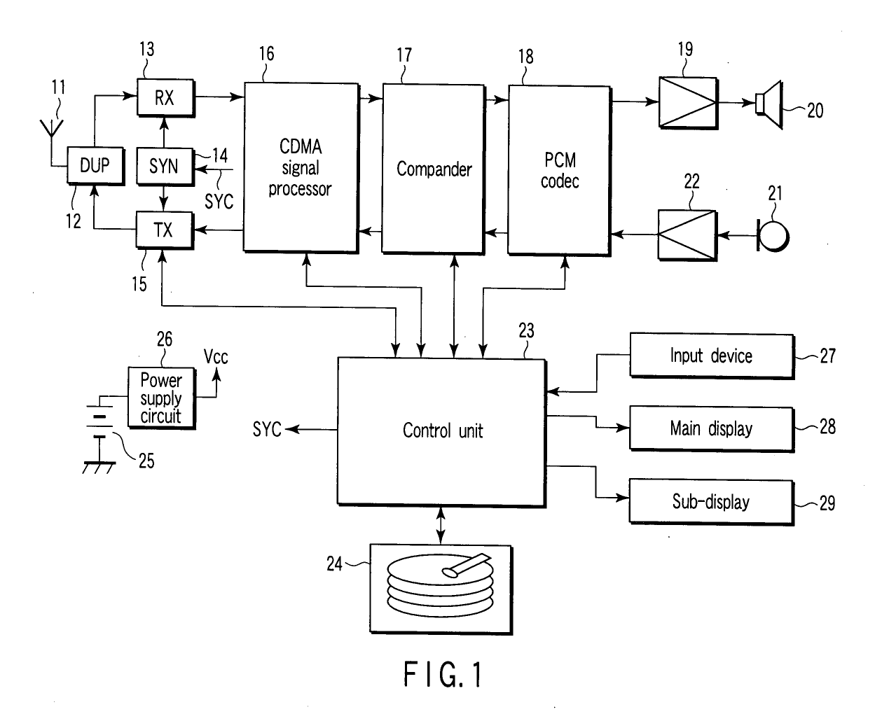

FIG. 1 is an exemplary block diagram showing the configuration of the cellular phone that is the embodiment of the portable electronic device regarding the invention.

A radio signal transmitted from a base station (not shown) is received by an antenna 11 then input to a receiving circuit (RX) 13 through an antenna duplexer (DUP) 12. The RX 13 mixes the received radio signal with a local oscillating signal output from a frequency synthesizer (SYN) 14 to frequency-convert (down-convert) it into an intermediate signal. And the RX 13 applies quadrature demodulation to the down-converted intermediate signal to output a received baseband signal. The frequency of the local oscillating signal generated from the SYN 14 is instructed by a control signal SYC output from a control unit 23.

The received baseband signal is input to a code division multiple access (CDMA) signal processor 16. The CDMA signal processor 16 has a RAKE receiver. The RAKE receiver applies back diffusion processing to a plurality of paths included in the baseband signal by diffusion signals, respectively. Signals of each path, which are processed by back diffusion processing, are applied with an arbitration in phase to be synthesized with one another. Thus, received packet data in a prescribed transmission format is obtained. The received packet data is input to a compressor/expander (hereinafter referred to as compander) 17.

The compander 17, in speech communication, decodes speech data included in the received packet data output from the CDMA signal processor 16 though a speech codec and outputs a digital speech signal obtained through the decoding to a pulse code modulation (PCM) codec 18. The PCM codec 18 applies PCM decoding to the digital speech signal to output an analogue speech signal. The analogue speech signal is amplified by a reception amplifier 19 then output from a loud-speaker 20.

The compander 17, in receiving e-mail or in down loading contents, transfers e-mail data or content data included in the received packet data to a control unit 23. The control unit 23 performs storage and reproduction processing of the e-mail data or content data as follows.

That is, the control unit 23 firstly stores the e-mail data or content data transferred from the compander 17 in a hard disk drive (HDD) unit 24. When an input device 27 inputs a display request for e-mail, the control unit 23 reads out the corresponding e-mail data from the HDD unit 24 to display it on a main display 28.

When a reproduction request of the contents is input by the input device 27, the corresponding content data is read out from the HDD unit 24. Then, if the content data is audio contents, the control unit 23 outputs the audio data to the compander 17. As a result, the audio data is decoded by the compander 17 and amplified by the amplifier 19 to be output from the loud-speaker 20 after being converted into an analogue signal by the PCM codec 18.

In contrast, if the content data is video contents, the control unit 23 decodes it by a video codec therein to display it on the main display 28. Also, in the case in which video data is imaged by a camera (not shown), the video data is displayed on the main display 28 under the control of the control unit 23.

On the other hand, in speech communication, a speech signal of a speaker input to a microphone 21 is amplified to an appropriate level by a transmission amplifier 22 then applied with PCM coding processing through the PCM codec 18 to be made into a digital audio signal, and input to the compander 17. The video signal output from the camera (not shown) is digitized though the control unit 23 and input to the compander 17. Text data such as an e-mail created in the control unit 23 is also input to the compander 17 from the control unit 23.

The compander 17 detects an energy level of the input speech from the digital audio signal output from the PCM codec 18 to determine a transmission data rate on the basis of the detection result. The compander 17 then encodes the digital audio signal into a signal in a format corresponding to the transmission data rate to generate audio data in accordance with the encoding. The compander 17 generates video data by encoding the digital video signal output from the control unit 23. And the compander 17 packetizes the audio data and video data in accordance with a prescribed transmission format by the multiplexer/demultiplexer therein to output it to the CDMA signal processor 16. Even when text data such as e-mail is output from the control unit 23, the text data is multiplexed into the transmission packet data.

The CDMA signal processor 16 applies spectrum diffusion processing to transmission packet data output from the compander 17 by using a diffusion code assigned to a transmission channel assigned to a transmission channel. The CDMA signal processor 16 then outputs its output signal to a transmitting circuit (TX) 15. The TX 15 modulates the spectrum-diffused signal by using a digital modulation system, such as a quadrature phase keying (QPSK) system or a quadrature amplitude modulation (QAM) system. The TX 15 synthesizes the transmission signal generated though the modulation with the local oscillating signal generated from the frequency synthesizer 14 to frequency-convert it into a radio signal. The TX 15 high-frequency-amplifies the radio signal so as to attain a transmission power level instructed from the control unit 23. The amplified radio signal is supplied to the antenna 11 and transmitted from the antenna 11 to the base station.

A sub-display 29 makes a display of information showing operation modes of the cellular phone, notification information of incoming calls and information showing a residual quantity or a charging state of a battery 25. A power supply circuit 26 generates a prescribed operation power supply voltage Vcc on the basis of the output from the battery 25 to supply it to each circuit unit. The battery 25 is charged by a charging circuit (not shown).

In the meantime, the HDD unit 24 has a disk shift repair function and a storage function of an occurrence frequency of disk shifts. When a so-called disk shift, in which a rotary shaft of a disk goes out of alignment due to impact, etc., occurs, the repair function calculates a shift amount of the disk shifts. At the next disk access time, the repair function compensates the disk shifts by finely adjusting a head position on the basis of the calculated value. The storage function of the occurrence number of times of the disk shifts counts the frequencies in which the head positioned has been finely adjusted in response to occurrences of the disk shifts and stores, in the disk itself, the counted value as the information showing the occurrence number of times of the disk shifts.

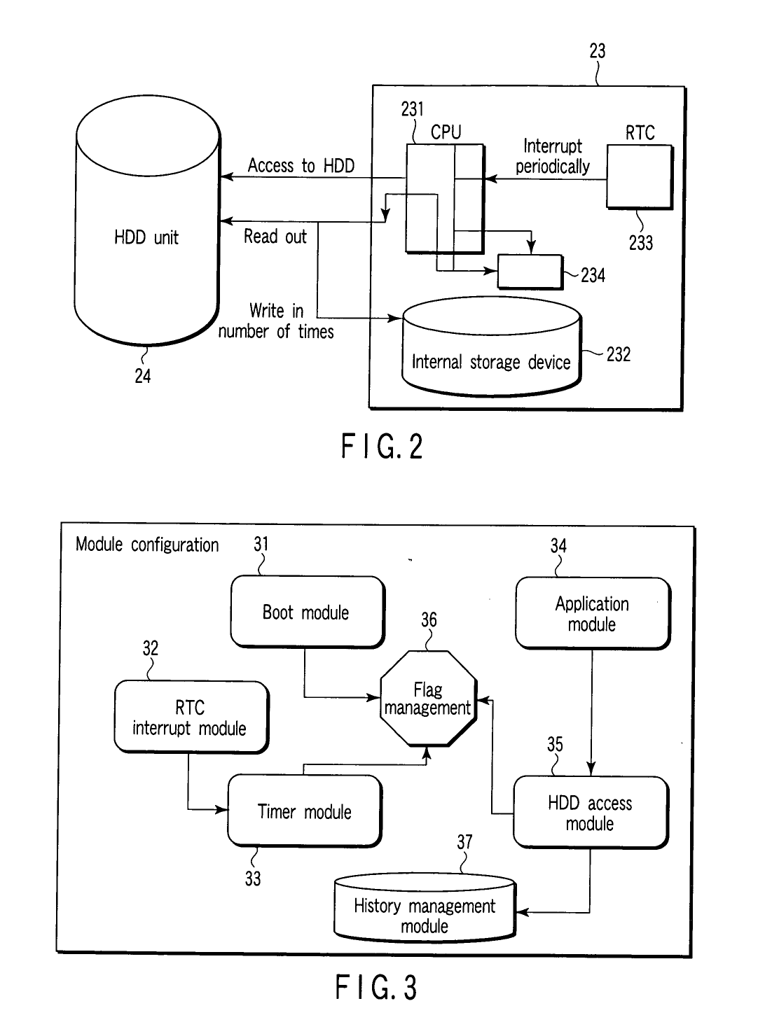

The control unit 23 is constituted as follows. FIG. 2 is the block diagram showing the configuration. The control unit 23 comprises a central processing unit (CPU) 231 consisting of a microprocessor, an internal storage device 232, a real time clock (RTC) 233 and a disk shift reading property flag 234.

The RTC 233 performs a clock operation for a current time and also generates interrupt signals at a fixed cycle or in prescribed conditions to supply it to the CPU 231. The generation cycle of the interrupt signals is set, to e.g., 24-hours. The prescribed condition is, for example, at 00:00:00 o'clock every day. The priority flag 234 indicates whether or not the control unit 23 is in a state in which it can read out the information showing the occurrence number of times of the disk shifts from the HDD unit 24 and defines a minimum time interval for reading out the foregoing occurrence number of times of the disk shifts. The propriety flag 234 is stored in a non-volatile memory such as a RAM.

The storage device 232 consists of a non-volatile semiconductor memory such as an EEPROM-NAND, the semiconductor memory stores a program group and management data required to achieve the present invention. FIG. 3 is a block diagram showing a module configuration of the program group.

The program group is composed of a BOOT management module 31, a real time clock (RTC) interrupt module 32, a timer module 33, an application module 34, an HDD access module, a flag management module 36 and a history management module 37.

The BOOT management module 31 makes the CPU 231 execute processing to initialize states of each circuit unit in the cellular phone when the power-on of the cellular phone is detected, and includes processing to raise a request, for setting the flag 234 to an ON state as one of an initializing setting routine, to the management module 36.

The RTC interrupt module 32 makes the CPU 231 execute interrupt processing for a time correction at reception of interrupt signals generated from the RTC 233 with a fixed cycle (e.g., 24-hour) or according to prescribed conditions (e.g., 00:00:00 o'clock every day), or when the cellular phone shifts from an out of service area to within a service area, and or at the time of completing speech communication. The interrupt module 32 includes processing to raise a start-up request to the timer module 33 as one of an interrupt processing routine. The interrupt processing for the time correction is performed by receiving standard time information included in a synchronous channel received from a system network of a CDMA and correcting the current time of the cellular phone, based on the standard time information.

When receiving the start-up request from the interrupt module 32, the timer module 33 determines whether or not the time interval from the preceding start-up request up to a start-up request of this time exceeds the defined time. And if the time interval exceeds the defined time, the timer module 33 makes the CPU 231 execute the processing to raise a request for setting the flag 234 to an ON state. The condition of the determination by the timer module 33 is not limited to this, and for instance, the timer module 33 may determine whether or not the time interval has reached the prescribed time.

When an access request to the HDD unit 24 has been raised by the execution of the application module 34, the HDD access module 35 makes the CPU 231 access the HDD unit 24 to execute data writing or reading.

The access module 35 determines whether the propriety flag 234 is in an ON state or an OFF state in preference to the processing of the data writing or reading. And in the event of the ON state, the access module 35 makes the CPU 231 perform the processing of reading the information showing the occurrence number of times of the disk shifts from the HDD unit 24. Further, after completing the processing of the reading of the occurrence number of times of the disk shifts, the access module 35 makes the CPU 231 raise a request for restoring the disk shift reading property flag 234 to the OFF state to the flag management module 36.

The management module 36 makes the CPU 231 perform processing to receive a request from the BOOT management module 31 and the timer module 33 and set the priority flag 234 to the ON state. The management module 36 also makes the CPU 231 perform processing to receive a request from the access module 35 and return the priority flag 234 to the OFF state.

The history management module 37 manages an operation history of the HDD unit 24 by using a history management area provided in the internal storage device 232. FIG. 7 is a view showing the configuration of the history management area and includes areas to store history information of 10 items at a maximum. Among these areas, the storage areas for the first item to the seventh item are used as a storage area Ea for storing usual HDD special histories, and the storage areas for the eighth item to tenth item are used as a history storage area Eb for disk shifts.

The history management module 37 makes the CPU 231 execute processing as follows. Every time the information showing the occurrence number of times of the disk shifts is read out from the HDD unit 24, the management module 37 determines whether or not the occurrence frequency which has been read out this time has changed to the occurrence frequency which was read out previously. Based on the determination result, every time the occurrence frequency which was read out this time has changed from the occurrence frequency which was read out previously, the management module 37 associates the information showing the occurrence number of times of the disk shifts which was read out this time with the information showing the reading date to store it in the storage area for the ninth item in the storage area Eb. And at this moment, the management module 37 shifts the information stored, up to that time, in the storage area for the ninth item to the storage area for the eighth item.

Every time the information showing the occurrence number of times of the disk shifts has been read out from the HDD unit 24, the management module 37 stores the information showing the date of the latest reading in the storage area of the tenth item of the storage area Eb together with the information showing the occurrence number of times of the disk shifts.

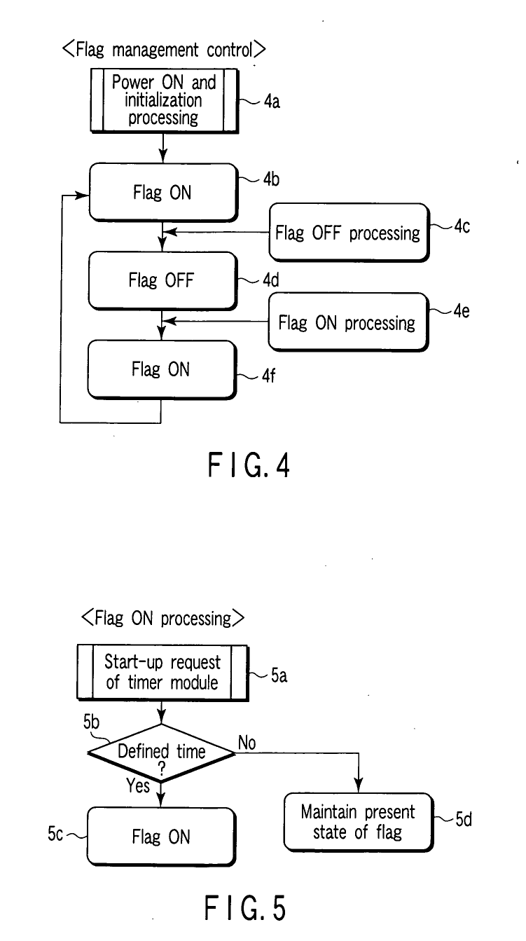

Next, a history management control operation of the HDD unit 24 by the cellular phone configured as mentioned above will be explained. FIG. 4 to FIG. 6 are flowcharts showing the control procedure and control contents.

When the power supply of the cellular phone is turned on, the CPU 231, as shown in FIG. 4, firstly performs initial setting processing for each circuit unit in a step 4a, and also sets the disk shift reading priority flag 234 to the ON state in a step 4b.

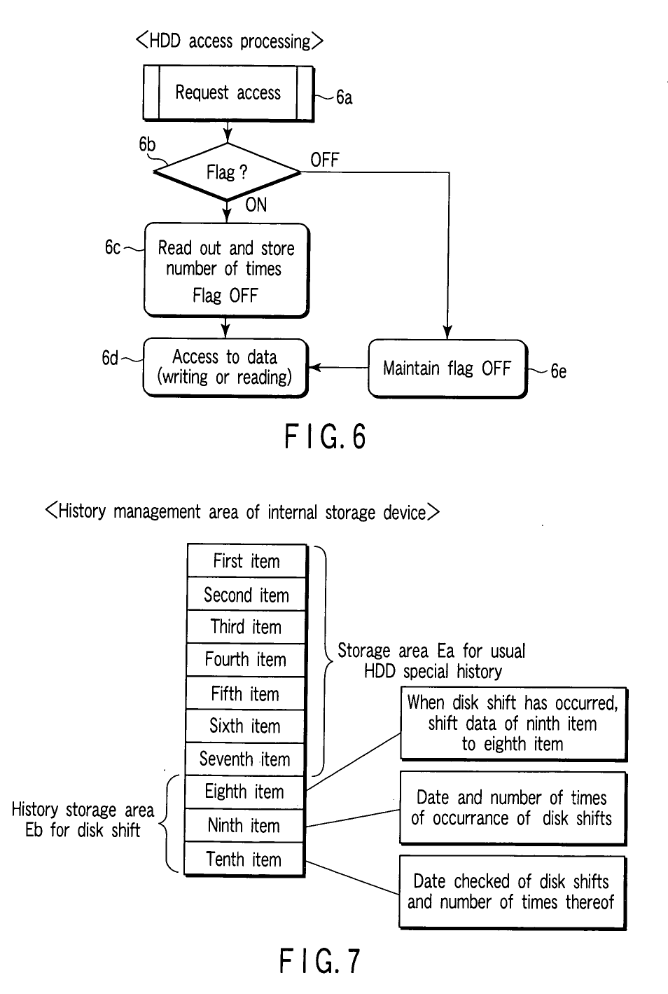

In this state, it is presumed that a user inputs a reproduction request for the contents through the input device 27. The CPU 231 then raises an access request for the HDD unit 24 in a step 6a, as shown in FIG. 6, so as to read out the corresponding content data from the HDD unit 24. And at the same time, in a step 6a, the CPU 231 determines the state of the priority flag 234. As the determination result, if the priority flag 234 is in the ON state, the CPU 231 shifts to a step 6c to read out the information showing the occurrence number of times of the disk shifts from the HDD unit 24.

In succession, in the step 6c, the CPU 231 compares the occurrence number of times of the disk shifts which has been read out this time with the occurrence frequency which was read out previously and stored in the storage area for the ninth item of the history management to determine whether the frequency value has changed or not. As the result of the determination, if the occurrence frequency which has been read out this time has changed from the occurrence number of times of the disk shifts which was read out previously stored in the storage area for the ninth item, after shifting the previous information stored in the storage area for the ninth item to the storage area for the eighth item, the CPU 231 associates the information about the occurrence number of times of the disk shifts to the information about the date of the reading thereof to store it in the storage area of the ninth item. The date of the reading is obtained from the RTC 233.

Simultaneously, the CPU 231 overwrites to store the information indicating the reading date of this time into the storage area for the tenth item in the history storage area Eb together with the read out information showing the occurrence number of times of the disk shifts. And finally, in a step 4c shown in FIG. 4, the CPU 231 executes processing for setting the priority flag 234 to the OFF state and returns the flag 234 to the OFF state in a step 4d.

When the foregoing storage processing of the information showing the occurrence number of times of the disk shifts is completed, the CPU 231 shifts to a step 6d to read out content data to be read out from the HDD 24. The CPU 231 then conducts processing to reproduce the read out content data.

When the reading out of the content data from the HDD unit 24 is completed, the CPU 231 waits for an occurrence of an access request in the step 6a in FIG. 6. When the access request is raised, the CPU 231 starts access to the HDD unit 24 in response to the access request. However, at this moment, the disk shift reading priority flag 234 is in the OFF state. So that, the CPU 231, as shown in FIG. 6, makes a shift from the step 6b to a step 6e, then, after maintaining the flag 234 in the OFF state, the CPU 231 performs data write-in or read-out processing in the step 6d.

That is to say, in this case, the CPU 231 does not perform the reading processing of the occurrence number of times of the disk shifts in the step 6c. Therefore, at this moment, the data writ-in or read-out processing to and from the HDD unit 24 is performed in a short while without causing a delay due to the reading processing of the occurrence number of times of the disk shifts. After this, similarly, the reading processing of the occurrence number of times of the disk shifts is not performed as long as the priority flag 234 is in the OFF state, and only the data write-in or read-out processing is performed.

Now, it is supposed, for instance, that 24 hours have elapsed from the time of the turning on of the power supply of the cellular phone and that the interrupt signal has been generated from the RTC 233. Then, when recognizing a star-up request for the timer module 33 due to the interrupt request in the step 5a as shown in FIG. 5, the CPU 231 determines whether or not a time longer than the defined time has elapsed from the preceding start-up request in step 5b. And if the time longer than the defined time has elapsed, the CPU 231 sifts to the step 5c to reset the propriety flag 231 to the ON state. If the propriety flag 234 has already been in the ON state, the CPU 231 keeps the ON state in the step 5d. In the step 5b, as mentioned above, the CPU 231 is not limited to such case of the ON state of the priority flag 234, the CPU 231 may, for instance, determines whether the time longer than the defined time has elapsed or not.

Therefore, when the access request to the HDD unit 24 is input in this state, because the priority flag 234 has been in the ON state, the CPU 231, as mentioned above, executes the reading processing of the information showing the occurrence number of times of the disk shifts in the step 6c. And if the occurrence frequency if the disk shifts which has been read out this time has varied from the previous occurrence frequency stored in the storage area of the ninth item in the history management area, after shifting the previous information which has been stored in the storage area of the ninth item to the storage are of the eighth item, the CPU 231 reads out the information showing the occurrence number of times of the disk shifts which has been read out this time to associate it with the information indicating the reading date and stores it in the storage area of the ninth item. And simultaneously, the CPU 231 overwrites to store the information about the reading date of this time (latest reading date) into the storage area of the tenth item in the storage area Eb together with the read out information showing the occurrence number of times of the disk shifts.

In contrast, if the occurrence number of times of the disk shifts that has been read out this time has not changed from the previous occurrence number of times of the disk shifts stored in the storage area of the ninth item in the history management area, the CPU 231 does not perform the storage processing of the information showing the occurrence number of times of the disk shifts which has been read out this time to the storage area of the ninth item, and performs only the storage processing of the information indicating the latest reading date to the storage area of the tenth item. Accordingly, the information showing the latest reading date is always stored in the storage area of the tenth item in the history storage area Eb.

When the forgoing reading and storage processing of the occurrence number of times of the disk shifts are completed, as shown in the step 6c in FIG. 6 and the step 4c in FIG. 4, the CPU 231 returns the disk shift reading priority flag 234 to the OFF state. Thereby, the priority flag 234 is returned to the OFF state in the step 4d.

As described above, in the embodiment, the CPU 231 sets the priority flag 234 to the ON state in synchronization with the interrupt signal periodically generated from the RTC 233. Then, only when the access request to the HDD unit 24 is made in this state, in preference to the data write-in or read-out processing, the CPU 231 reads out the information showing the occurrence number of times of the disk shifts from the HDD unit 24 to store it in the history management area in the internal storage device 232 together with the information indicating the reading date. And after completing the reading processing, the CPU 231 returns the priority flag 234 to the OFF state.

Accordingly, the time interval of the reading processing of the information showing the occurrence number of times of the disk shifts is set so as to be longer than the period to set the priority flag 234 to the ON state, i.e. 24-hours. Thereby, the cellular phone can extremely reduce the frequency of the reading of the occurrence number of times of the disk shifts in comparison with the case that performs reading processing of the occurrence number of times of the disk shifts for each usual data write-in or read-out processing, and consequently lengthen the service life of the battery by reducing the current consumption. The delay in the data write-in or read-out processing is limited only to the case in which the reading processing of the information showing the occurrence number of times of the disk shifts is performed. Therefore, the cellular phone can keep an access processing speed to the HDD unit 24 at a high speed.

Being set to read out the information showing the occurrence number of times of the disk shifts along with the usual data write-in or read-out processing, the durability of the HDD unit 24 can be enhanced by reducing the frequency of the disc access.

The priority flag 234 being set to the ON state in response to the power on, the cellular phone can always read out the information showing the occurrence number of times of the disk shifts at the first disk access after the power on. Thereby, the cellular phone can accurately record the occurrence situation of the disk shifts in the power off period without omission.

Furthermore, the HDD unit 24 reads out the information showing the occurrence number of times of the disk shifts in preference to the processing of the data writing or reading. Thereby, the cellular phone can always read out the information showing the occurrence number of times of the disk shifts in preference to the data write-in or read-out processing. In general, in the cellular phone, sometimes an access becomes impossible due to a decrease in a battery voltage or a failure occurs resulted from an impact during data writing or reading to/from the HDD unit 24. However, by reading the information showing the occurrence number of times of the disk shifts in preference, for instance, to data write-in or read-out processing, even when the aforementioned failure occurs, it becomes possible for the cellular phone to surely read out the information showing the occurrence number of times of the disk shifts.

Further, since the information showing the occurrence number of times of the disk shifts is stored only in the storage area of the ninth item in the history management area and the previous information, before being changed, is shifted to the eighth storage area to leave it as it is, the cellular phone can specify the time zone in which the impact was made from the two items of the forgoing information.

In addition, the cellular phone update-stores the latest reading date in the storage area of the tenth item in the management area. The cellular phone therefore can specify the elapsed time from the latest date of the change in the occurrence number of times of the disk shifts up to the latest date of the reading of it. Thereby the operation state of the HDD unit 24 from the time at which the impact was made on the HDD unit 24 up to the current time can be known.

The present invention is not limited to the above-described embodiment. In such embodiment, the disk shift reading priority flag 234 is set to the ON state in synchronization with the interrupt signal for the time correction generated from the RTC 233. However, it is a possible approach to set the period of setting the priority flag 234 to the ON state within a range in which the period does not become shorter than a minimum value of the usual data access time intervals to the HDD unit 24 by generating a signal with a period shorter than the interrupt period for the time correction. On the contrary, it is also considered to set the period of setting the priority flag 234 to the ON state so as to become longer than the time correction period by generating a signal with a period longer than the interrupt period for the time correction.

The reading of the information showing the occurrence number of times of the disk shifts from the HDD unit 24 in the midst of or after the usual data write-in or read-out processing is a possible approach. The aforementioned embodiment has been configured to store only two items of the histories of the changes in the occurrence number of times of the disk shifts, though it may be configured to store the histories of more than three items. By this, although the storage capacity of the history storage area is required to be increased, it becomes possible to grasp, in detail, the history of the impacts made on the HDD unit 24. It is preferable to compress-decode the information showing the occurrence number of times of the disk shifts and the reading date to store them. By accomplishing the above, the cellular phone becomes able to store a larger number of items of information in the history storage area with a limited storage capacity.

Information related to the disk shifts may include not only the occurrence number of times of the disk shifts but also dates of occurrences of the disk shifts, amounts of the disk shifts, numbers of the disks with failures caused therein, etc.

Having described the cellular phone as an example in the foregoing embodiment, the present invention is applicable to other portable electronic devices, such as a PDA, a portable game machine, a portable audio/video player and a digital camera. In addition, various modifications may be made for a module configuration to perform history management of a hard disk unit, a control procedure and control contents, without departing from the sprit or scope of the general inventive concept.

This invention is not limited to the above-mentioned embodiment as it is, and may be embodied in various forms without departing from the sprit or scope of the general inventive concept thereof. Variations of the invention can be formed by appropriately combining a plurality of constituent elements disclosed in the forgoing embodiments. Some of the elements, for example, may be omitted from the constituent elements shown in the embodiments mentioned above. Further, the constituent elements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic device, comprising:
a disk storage unit configured to store an information related to disc shifts when the disc shifts are caused;
an access unit configured to access to the disk storage unit to write in or read out data if access requests to the disk storage unit are made;
a memory configured to store a state identifier indicating whether or not to permit reading information related to the disk shifts;
a first identifier controller configured to temporarily change the state identifier stored in the memory from a first state to a second state;
a read-out controller configured to read out the information related to the disk shifts from the access unit along with a data writing or reading operation performed by the access unit when the access requests are made in a state in which the state identifier is set to the second state; and
a second identifier controller configured to return the state identifier from the second state to the first state in response to a completion of reading out information related to the disk shifts.

2. The portable electronic device according to claim 1, wherein
the first identifier controller changes the state identifier from the first state to the second state if a power source of the portable electronic device is turned on.

3. The portable electronic device according to claim 1, wherein
the first identifier controller changes the state identifier at a determined time interval from the first state to the second state.

4. The portable electronic device according to claim 1, wherein
the read-out controller reads out information related to the disk shifts from the storage unit in preference to the data writing or reading operation performed by the access unit.

5. A portable electronic device, comprising:
a disk storage unit configured to store an information related to an occurrence number of times of disk shifts when the disc shifts are caused;
an access unit configured to access the disk storage unit to write in or read out data if access requests to the disk storage unit are made;
a memory configured to store a state identifier indicating whether or not to permit reading information related to the occurrence number of times of the disk shifts;
a first identifier controller configured to temporarily change the state identifier stored in the memory from a first state to a second state;
a read-out controller configured to read out the information related to the occurrence number of times of the disk shifts from the access unit along with a data writing or reading operation performed by the access unit if the access requests are made in a state in which the state identifier is set to the second state; and
a second identifier controller configured to return the state identifier from the second state to the first state in response to a completion of reading out information related to the occurrence number of times of the disk shifts.

6. The portable electronic device according to claim 5, wherein
the first identifier controller changes the state identifier from the first state to the second state at a determined time interval which is set longer than a minimum value of occurrence time intervals of the access requests.

7. The portable electronic device according to claim 5, wherein
the first identifier controller changes the state identifier from the first state to the second state if a power source of the portable electronic device is turned on.

8. The portable electronic device according to claim 5, wherein
the read-out controller reads out information showing the occurrence number of times of the disk shifts from the disk storage unit in preference to the data writing or reading operation performed by the access unit.

9. The portable electronic device according to claim 5, further comprising:
a disk shift history controller configured to store the information showing the occurrence number of times of the disk shifts which is read out from the disk storage unit in a non-volatile memory by associating the information with information indicating a reading date, wherein
the disk shift history controller comprises
determination means for determining whether or not an occurrence number of times which is read out this time differs from an occurrence number of times which was read out previously at every time when the information showing the occurrence number of times of the disk shifts is read out from the disk storage unit;
means for additionally storing the information showing the occurrence number of times of the disk shifts which is read out this time in a first storage area of the non-volatile memory by associating the information with the information indicating the reading data; and
means for updating and storing information showing the latest reading date at every time when the information showing the occurrence number of times of the disk shifts is read out from the disk storage unit.
